(19) United States
(12) Patent Application Publication
(10) Pub. No.: US 2006/0167723 A1
(43) Pub. Date: Jul. 27, 2006

(54) Method of treating dependencies

(76) Inventor: L. Martin Berg, Carmel, IN (US)

Correspondence Address: BARNES & THORNBURG, 11 SOUTH MERIDIAN, INDIANAPOLIS, IN, 46204, US

(21) Appl. No.: 11/335,097

(22) Filed: Jan. 18, 2006

Related U.S. Application Data
(60) Provisional application No. 60/645,828, filed on Jan. 21, 2005.

(51) Int. Cl. G06F 19/00; G09B 23/28

(52) U.S. Cl. 705/3; 434/262

(57) ABSTRACT

A method and apparatus of treating an addiction is provided. The method includes evaluating the individual to determine the individual's needs. An individual admitted to the program undergoes a supervised treatment protocol that may include education and initial treatment, group therapy, and relapse prevention. There may also be a maintenance protocol following completion of the treatment protocol. In the case where the individual has been arrested for a crime, the supervision may include detention and probation aided by accountability devices.

This application claims priority to and the benefit of U.S. Provisional Patent Application No. 60/645,828, filed 21 Jan. 2005, the disclosure of which is now expressly incorporated herein by reference.

### FIELD OF THE INVENTION

The present invention relates generally to a method of treating a dependency, for example and without limitation a chemical dependency such as addiction(s) to alcohol or other drugs, in individuals, and more particularly to individuals convicted of a crime who would otherwise be considered for an executed sentence to prison.

### BACKGROUND OF THE INVENTION

While the method disclosed herein could be used for the treatment of any individual having a chemical dependency, it is also suitable for criminal offenders in general and more particularly to non-violent offenders. Thus, the method provides an outpatient treatment alternative to prison incarceration for non-violent offenders who are chemically dependent (for example and without limitation, addicted to alcohol and/or other drugs).

According to the American Medical Association, Chemical Dependency (broadly including for example and without limitation alcoholism and drug addiction) is an incurable, progressive and, if not effectively treated, fatal disease. This disease not only affects the whole person, but also those around the chemically dependent individual. Unlike most diseases, Chemical Dependency often causes behavioral patterns that society deems unacceptable. In many instances, Chemical Dependency leads to behavior defined as criminal, for example and without limitation, driving while intoxicated (DWI), driving under the influence (DUI), theft, robbery, battery, rape and/or other violent crimes. An individual convicted of a crime illustratively may receive an executed sentence, which includes time behind bars.

As the disease progresses, often the severity of the inappropriate or criminal behavior progresses as well. Therefore, the individuals perhaps most in need of treatment have often already reached the later and more severe stages of the disease. Chemical dependency treatment programs have typically overlooked or not effectively treated such individuals. While a 30-day inpatient hospitalization was the preferred treatment method for alcoholism and drug addiction some fifteen to twenty years ago, current inpatient programs are expensive and may not be suitable to replace an executed sentence for an individual in the target population as defined herein below. Outpatient programs, which are more cost effective, and may even be covered by health insurance or other financial aid, have not typically been designed to treat such individuals either.

The most common type of out-patient program is the Intensive Out-patient Program (IOP), which is typically seventy-two hours long, usually nine-hours-per week for eight weeks. These IOPs, however, are primarily geared for individuals whose disease has not progressed to as severe a degree as that of the target population. An IOP may not be a viable option for the target population for any number of reasons. For example and without limitation, when an individual is subject to a one-year or two-year executable sentence, a judge might not consider an eight-week IOP as a viable clinical alternative. A prosecutor and/or the victims, if any, might also object to the IOP alternative. Also, many repeat offenders have already been through one or more IOP treatments by the time the sentencing judge is considering an executed prison sentence. To sentence the convicted individual to an IOP treatment at this point would seem to many judges, prosecutors, and/or victims as a futile and/or ineffective “slap on the wrist.” Still, this is currently the only treatment alternative available in most cases.

The criminal justice system, broadly defined as and including justice systems now existing throughout the United States at varying levels of government, has generally not been successful in effectively dealing with non-violent, chemically dependent individuals or offenders, referred to herein generally as the “target population.” In some jurisdictions courts have instituted a concept called “Drug Court” or “DWI Court”. These are special courts that offer a high degree of supervision along with referral to local treatment providers; usually for IOP treatment. While the Court supervision is very effective in reducing recidivism, the actual treatment being provided is usually very generic. The drug court participants are usually mixed in with patients at various levels in the progression of the disease. Some of the options for dealing with individuals in the target population have included probation, shock probation, inter-lock devices, home detention, work release, jail, and finally prison. While in some jurisdictions these options are combined with referral to generic alcohol and drug treatment programs on a case-by-case basis; in many instances this target population is considered “untreatable” because specialized treatment options have not existed. Moreover, these options generally are aimed at controlling the behavior of the offender while under supervision, rather than on treating the underlying causes.

For example, research and experience show that many co-existing diseases, disorders or conditions, for example and without limitation bipolar disorder, depression, co-dependency, anxiety disorders, and the like serve to exacerbate chemical dependency. Yet, these exacerbating conditions typically remain undetected, undiagnosed and untreated, thus reducing the chances for long-term rehabilitation of the chemical dependency. This is not surprising since the above options for dealing with the target population are not typically overseen by qualified professionals, such as for example and without limitation mental health professionals. For example, in the case of incarceration, which is typically expensive even without treatment programs, programs to treat the individual's chemical dependency or other psychiatric disorders have been curtailed or eliminated for one reason or another. Thus, the target population may go untreated while incarcerated, or, in the alternative, an individual in the target population may be sentenced to home-detention without treatment in order to free up space in the prison for a more violent offender. In any event, the personnel operating the home-detention program are usually probation officers and are rarely trained mental health professionals. Home detention has been used therefore to serve as a cost-efficient means for merely controlling the behavior of an individual in the target population for a specific period of time, rather than for treating the individual's chemical dependency or other psychiatric disorders. Lacking a treatment of the chemical dependency and/or other disorders, released individuals in the target population are likely to return to former addictive, disruptive, and/or criminal behavior, perhaps leading to further convictions and incarceration, or even premature death.

There are both non-financial and financial costs associated with the incarceration in lieu of treatment of the target population. One example of a non-financial cost is the premature release from prison of more dangerous offenders due to prison overcrowding, which may be caused in part by the incarceration of less dangerous felons in the target population. As noted above, by placing individuals from the target population in a treatment program in lieu of incarceration, prison space can be freed up for perpetrators of more serious crimes. The financial cost to taxpayers to incarcerate individuals in the target population is extremely high. For example the Indiana Department of Correction states on their official website the cost of incarceration per inmate is nearly twenty-one thousand dollars ($21,500.00) per year. In addition to the actual cost of incarceration, financial burdens are placed on taxpayers due to increased families on public assistance while their bread-winner is incarcerated, lost tax revenue from the incarcerated individual(s), increased cost to the court system, as well as many other indirect costs. So too, as noted, the untreated target population may face further convictions and incarcerations, perhaps even as more violent or dangerous criminals, thus adding further costs for the judicial and penal systems.

In contrast to the foregoing options, the method disclosed herein uses home detention as a therapeutic tool in the treatment of the target population. Moreover, the method reduces the likelihood of recidivism and provides a more cost-effective alternative to incarceration. Indeed, in the illustrative case of Indiana, for every 35-40 offenders who are successful in completing the program disclosed herein, the taxpayers of that state might save in excess of one million dollars. The method disclosed herein provides for the judicial system an alternative to incarceration.

Broadly speaking, the method provides an effective treatment program for anyone with a chemical dependency. In the more specific case of an individual from the target population, the method offers the individual an effective treatment program, but it also offers sentencing judges at least two satisfying objectives. First, illustratively and without limitation, the method provides a realistic treatment solution while also providing an appropriate corrective punishment for recognized criminally defined behavior. Second, illustratively and without limitation, the method addresses the real cause of habitual criminal behavior, the medical disease of chemical dependency, and starts the recovery or rehabilitation process thus enabling the person to better function as a law-abiding citizen.

### SUMMARY OF THE INVENTION

The present invention comprises one or more of the features identified in the various claims appended to this application and combinations of such features, as well as one or more of the following features or combinations thereof.

A method of treating an individual having a dependency is provided. The method generally comprising the steps of evaluating the individual; treating the individual based upon the evaluating step; and providing the individual with maintenance treatment. The maintenance treatment may be designed to help the individual avoid a relapse. The evaluation step may include performing a holistic evaluation comprising a psychiatric evaluation, a psychological evaluation, a physical evaluation, and/or a physiological evaluation of the individual. A personal history and background investigation may also be produced on the individual.

The individual may be a non-violent offender of the one or more laws. Any such offenders are known as the target population. The offender may be sentenced to the home-detention treatment program in lieu of serving an executed sentence. The non-violent offender may apply for the treatment program. The offender's application may be one of the conditions of a plea bargain. Any offender in the treatment program will be supervised during at least a portion of the treatment program. The supervision may include any of a number of suitable detention situations. One suitable detention situation or means includes home detention. Such a detention may be implemented with the use of one or more accountability devices. Suitable accountability devices include ankle bracelets. The offender may also be placed on probation during all or a portion of the treatment program. If the judicial system agrees to the offender's request for referral to the treatment program, then the offender will be referred for evaluation. In some instances the offender may take the initiative to complete the evaluation phase prior to sentencing. In addition, offenders who have been sentenced, and/or have completed a sentence and are on parole may be referred to the program.

Any individual, which includes offenders, will be evaluated for suitability for the treatment program. The treating of the individual may include a plurality of treatment phases. Illustratively these phases may overlap and may include an initial treatment phase, a therapy phase and a relapse prevention phase. Generally, phase I is concerned with educating the individual or patient in order to help the individual recognize that he or she is suffering from chemical dependency and then help that individual to reduce and/or eliminate or otherwise overcome the individual's denial that he or she has a chemical dependency. Phase II is generally concerned with the individual's recovery. Phase III is generally concerned with preventing a relapse and with the emotional development of the individual. Each of these phases may include individual, group and possibly, family therapy. Each of these phases may further include participation on one or more self-help programs, such as one of any number of 12-step programs or other self-help programs. The initial treatment phase may further include individual therapy. One or more members of a multidisciplinary team administer the program. The members of the multidisciplinary team illustratively may be certified and/or licensed professionals in their respective fields. Professionals outside of the multidisciplinary team may also be consulted and may assist in treating the individual. The treatment program may be individualized for each participating individual. The individual may have to be treated for one or more other problems or disorders other than the chemical dependency at any time during the treatment program. The treatment for other disorders may be by professionals that are or are not members of the multidisciplinary team. The treatment program may be administered by one or more processing units. The one or more processing units may run one or more software programs, which may create a patient-centered database. The database may contain information gathered from and about the individual during the evaluation step. Additional information may be added as the patient progresses through treatment.

### BRIEF DESCRIPTION OF THE DRAWINGS

FIG. 1 is a flow chart of an illustrative method of treating addictions.

FIG. 2 is a flow chart of an illustrative evaluation step of the illustrative method depicted in FIG. 1.

FIG. 3 is a flow chart of an illustrative supervision protocol of the illustrative method depicted in FIG. 1.

FIG. 4 is a flow chart of an illustrative consultation step of the illustrative method depicted in FIG. 1.

FIG. 5 is a flow chart of an illustrative treatment step of the illustrative method depicted in FIG. 1.

FIG. 6 is a flow chart of an illustrative phase of the treatment protocol of the illustrative method depicted in FIG. 1 and FIG. 5.

FIG. 7 is a flow chart of another illustrative phase of the treatment protocol of the illustrative method depicted in FIG. 1 and FIG. 5.

FIG. 8 is a flow chart of another illustrative phase of the treatment protocol of the illustrative method depicted in FIG. 1 and FIG. 5.

FIG. 9 is a flow chart of an illustrative maintenance phase of the illustrative method depicted in FIG. 1 and FIG. 8.

FIG. 10 is a flow chart of an illustrative referral process for the illustrative method depicted in FIG. 1.

FIG. 11 is a schematic diagram of an illustrative system for use with the illustrative method depicted in FIG. 1.

### DETAILED DESCRIPTION OF THE INVENTION

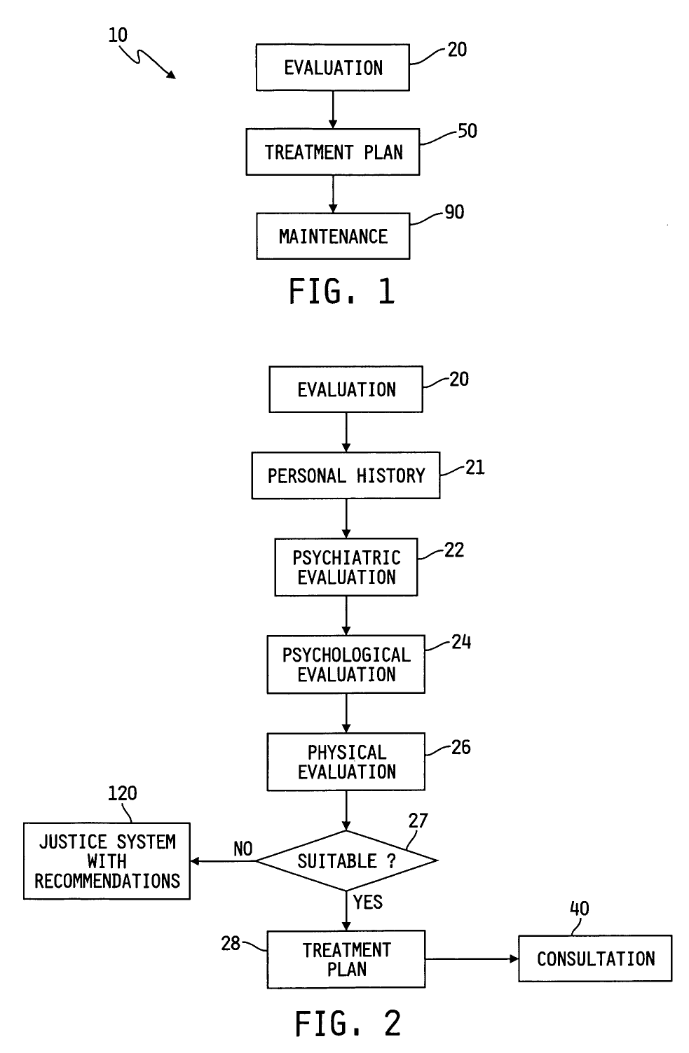

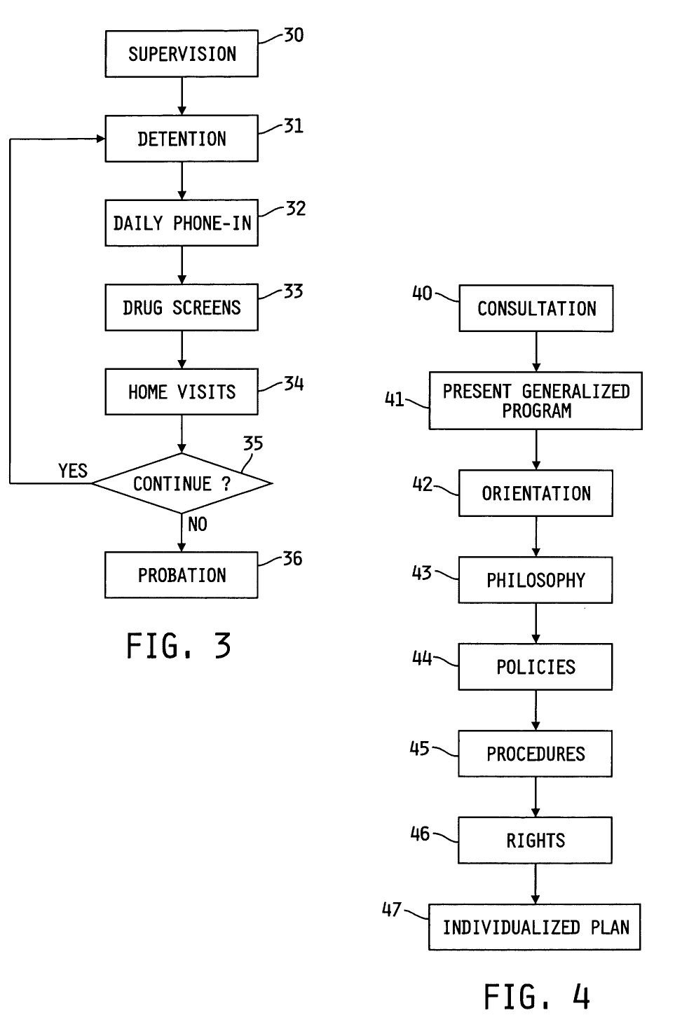

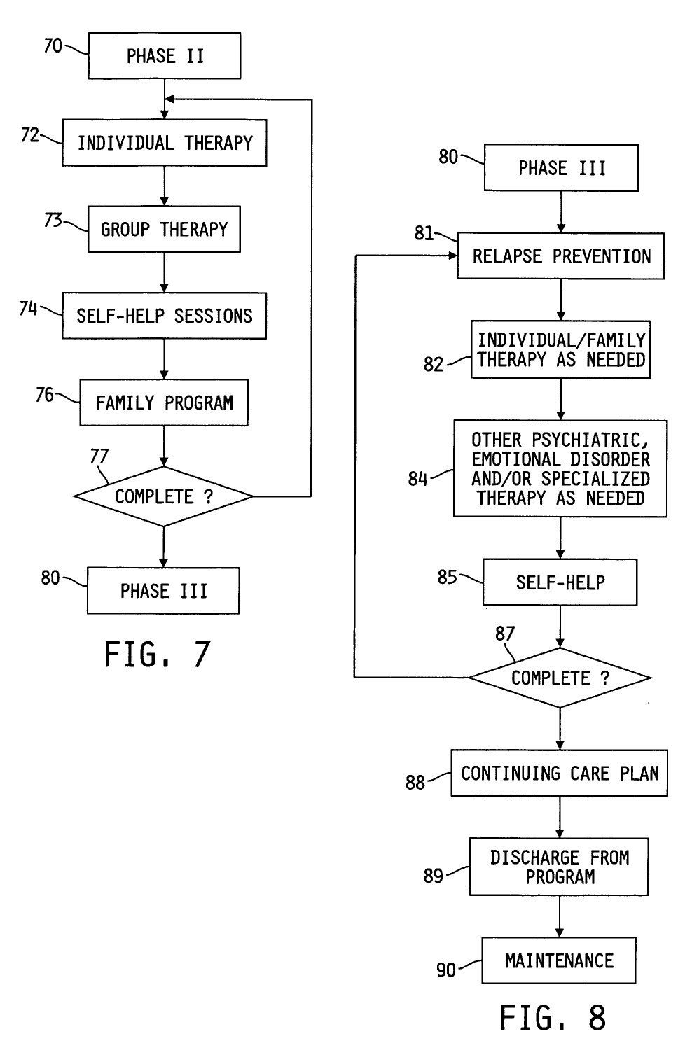

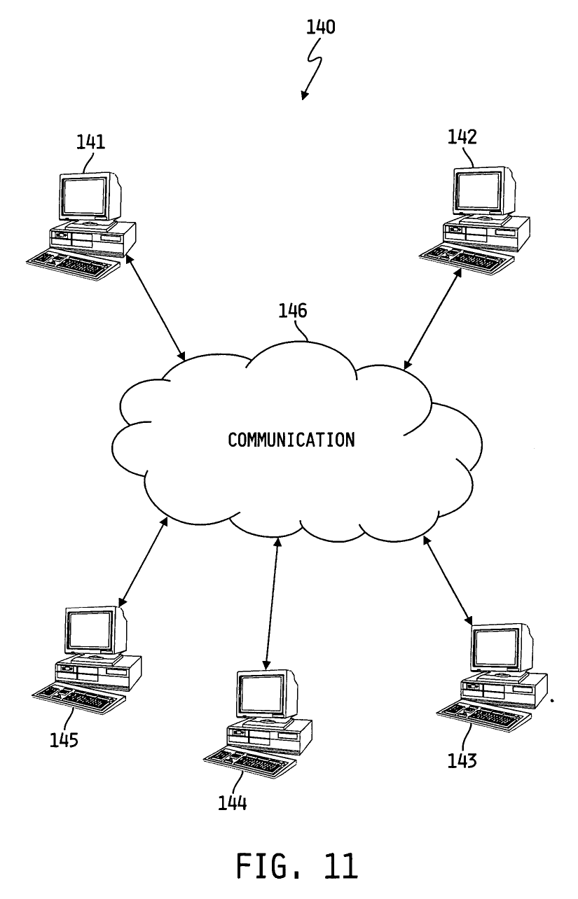

Referring to FIGS. 1-11, an illustrative treatment program or method 10 for treating addictions is disclosed. Whenever any examples are given in this application, such examples are meant to be illustrative in nature and are without limitation. While the generalized treatment program or method 10 may be adapted to treat any type of dependency, it is useful in the treatment of chemical dependency in general and for the treatment of non-violent, chemically dependent felons, who may face one or more years of imprisonment (an executed sentence), the “target population.” For example, the judicial system may use the method 10 as an alternative sentencing option for individuals in the target population as best seen in FIGS. 10 and 11. The method or program 10 illustratively may comply with applicable local, state and federal rules, regulations, laws, ordinances, standards, certification requirements and the like; and may choose to meet accreditation requirements established by any desired accrediting organization such as for example and without limitation the Joint Commission on Accreditation of Healthcare Organizations (JCAHO) or the Commission on Accreditation of Rehabilitation Facilities (CARF). So too, any professionals involved in the multidisciplinary team illustratively may be licensed, certified or accredited by their respective governing bodies. The method involves a supervisory detention program, such as for example home detention, that is integrated with treatment of underlying behavioral, medical, social and psychological conditions or disorders that produce repeat chemical dependency in individuals or patients. The method takes a holistic approach in that each individual or patient is evaluated to determine not only how far the disease of chemical dependency has progressed within the patient but also what other psychiatric/emotional, physical, familial, spiritual, vocational and social problems, conditions, disorders and the like may also be interfering with the patient's ability to live a life free from chemical dependency. These problems illustratively become part of the patient-centered treatment plan for each patient.

Referring to FIG. 1, the process, program or method 10 for treating dependencies generally comprises the steps of evaluating 20 the individual or patient, treating 50 the patient's addiction, and maintaining 90 or continuing the recovery from the addiction. The method 10 may further comprise the step of consulting 40 with one or more professionals (FIG. 4). As best seen in FIG. 2, the evaluating step 20 illustratively may comprise a number of sub-steps resulting in a bio-psycho-social evaluation of the individual. During the evaluation step 20, one or more members of an illustratively multidisciplinary team illustratively is trying to determine the individual's suitability for the program 10, and, if the individual is deemed suitable, the optimum protocol for the individual's treatment. The multidisciplinary team may include for example and without limitation one or more: psychiatrists, psychologists, psychotherapists, social worker, physician, physicians assistant, nurses and/or other health professionals; and may further include or receive input from other professionals such as for example and without limitation judges, lawyers, clerks, and other employees of the judicial system; probation officers, prison employees and/or other professionals of the penal system; police officers, sheriffs deputies, marshals, and/or other law enforcement professionals; counseling professionals, therapists, religious professionals, guardians, and/or other social work professionals; mentors; sponsors; individuals having successfully completed the program 10 in the past, and/or any other person deemed appropriate to the treatment of the individual. The patient's spouse or significant other and other people close to the patient may be interviewed in the evaluation process to obtain additional information and to verify information given by the patient.

The evaluating step 20 illustratively may include the steps of determining the specific treatment needs of the individual; determining patient suitability for the program 10; and determining the probability that the individual will successfully complete the program 10. These determinations may be accomplished for example through the bio-psycho-social evaluation; although, other factors may be considered as well. Illustratively and without limitation, some criteria relevant to such determinations comprise: whether the individual has been diagnosed as having a dependency, either in the past or by the multidisciplinary team during the evaluating step 20; whether the individual has a disqualifying factor such as for example a violent or sexual predatory history; whether the individual has the ability and willingness to, comply with all policies, rules and procedures of the program 10; whether the individual has the ability and willingness to attend and actively participate in the entire protocol prescribed for the program 10; whether the individual has the availability to attend all treatment sessions; whether the individual has the ability and willingness to attend and participate in specified self-help programs; whether the individual has the availability and willingness of the individual's spouse or significant other, if any, to participate in a Family Program as appropriate and if specified; whether the individual has the ability and willingness to undergo a psychiatric evaluation and follow all recommendations of the consulting/staff psychiatrist; whether the individual has the ability and willingness to undergo psychological testing by a specified psychologist and follow all resulting recommendations of the consulting/staff psychologist; and whether the individual has the ability and willingness to undergo a physical examination and/or medical treatment and follow all recommendations of the consulting/staff physician, with results to be submitted to the program 10 team to aid in the evaluation and treatment of the individual. In the case where the program 10 is being considered in lieu of an executed sentence for an individual convicted of a crime, i.e., for an individual in the target population, other relevant criteria include for example and without limitation whether the individual volunteered for the program 10, and whether the individual volunteered prior to sentencing, in any event, illustratively no one criteria is dispositive, and the team will consider each individual on a case-by-case basis.

The evaluating step 20, illustratively may begin with the taking of a personal history 21 of the individual. This history illustratively may include for example and without limitation the individual's: history of alcohol use, history of drug use, history of using other addictive substances such as for example and without limitation illegal “street drugs” or abuse of prescriptions drugs, history of prior treatment for chemical dependency; history of prior participation in counseling programs; sexual history; history of abusing or being abused by others; financial history; legal history and criminal record; employment history; employability; educational background and history; family history; and any other information that might indicate the individual's suitability for the program 10. For example, the history might also include the present familial, health, fiscal, and employment status of the individual. The history might further include the history of the patient's immediate family. The patient's history may be gleaned from personal interviews with the individual, collateral interviews with the individual's family members, employer(s), colleagues, friends, personal healthcare professionals, and the like. All information will be obtained and maintained according to all applicable laws including for example and without limitation privacy laws, confidentiality laws and the Health Insurance Portability and Accountability Act of 1996 (HIPAA) and Federal Confidentiality Regulations (42 CFR Part 2).

The evaluating step 20 as illustrated in FIG. 2 may further comprise a psychiatric evaluation 23, a psychological evaluation 26, for example and without limitation a Minnesota Multiphasic Personality Inventory (MMPI) may be administered; and a physical evaluation 29 by one or more psychiatrist(s), psychologist(s), and/or physician(s). Illustratively, each evaluation step 22, 24, 26 may result in a determination that further evaluation of that type or some specific treatment protocol is required prior to the individual being approved or referred to the consultation step 40 and treating step 50, if at all. It may be determined, for example, that the individual needs further evaluation of that kind (for example, psychiatric, psychological, or physical evaluation) or of any other kind already performed, yet to be performed or not currently scheduled to be performed; that the individual needs a certain type of outside psychiatric, psychological, or physical medical treatment prior to continuing with or ongoing during the treatment method 10; or that the individual is not a suitable candidate for the treatment 10 at all, even with further evaluation and/or outside treatments. Thus, if the individual has been deemed to be not a suitable candidate for the treatment program 10, then the multidisciplinary team may recommend some other form of treatment or program, or, in the case of an individual referred to the program 10 in lieu of an executed sentence, as will be explained further below, the team may recommend that the individual is not a good candidate. In such a case, the individual may be returned to the judicial system 120. Illustratively, at step 28, so long as the individual has been determined to be suitable 27 for the treatment 10, a specific treatment plan is devised for the individual. The treatment plan may be discussed with the individual as desired, for example during a consultation 40.

Non-exclusive and non-limiting examples of further evaluation and/or treatment might be for example psychiatric or psychological testing, psychiatric supervision for a specified period of time including the entirety of the program 10, marriage counseling, financial counseling, sex therapy, commitment to a detoxification program or an in-patient treatment program for chemical dependency, prescribing of one or more drugs such as for example and without limitation anabuse, disulfiram, naltrexone, or any other suitable medication(s), treatment of one or more physical ailments such as for example and without limitation an ulcer, or a slipped disk, or obesity, and the like; and/or treatment for one or more learning disabilities, neurological disorder(s) and/or mental disorders. This further treatment may occur before beginning treatment, during treatment and/or after treatment as deemed necessary. The further treatment may also be formally integrated into Phase III 80, if necessary, as will be explained.

The program 10 is one of supervised treatment 30. Once the individual has been accepted for the treatment program or method 10, the individual or patient illustratively will be assigned to one of a number of suitable detention 31 or supervisory environments, which help to ensure that the individual will remain alcohol and drug free for example, or free from other dependency during the course of the program 10. For example and without limitation, the individual might be sentenced to home detention by the presiding judge. Thus the supervisory environment serves as a therapeutic tool as well, and in the case of the target population, as a punitive tool in the form of detention 31 and supervisory oversight 32-34. The supervising environment or step 30 illustratively will be present in each of the consultation 40, treatment 50, and maintenance 90 steps, and may even be applied to the evaluation or evaluating step 20.

As noted, the supervisory environment 30 may comprise some form of detention 31, for example and without limitation the individual's home or another's home in the case of home detention, a half-way house, or a barracks or other communal building in the case of assignment to a boot-camp program. It is even feasible that the individual could complete the program from prison or jail, especially in the case where the individual is sentenced to a minimum security facility or farm system. In addition, the individual may have already been sentenced, or may have already completed an executed sentence and may be on parole when referred to the treatment program. The supervising step 30 illustratively may be implemented by a detention program representative and may further comprise various supervisory oversight such as for example phone reporting 31, drug and/or alcohol screening 32, and visits 33 by one or more members of the multidisciplinary team to the place of detention 31 (e.g., home, half-way house, barracks, communal building, prison and the like without limitation). The foregoing supervision 30 helps to ensure the individual remains clear of the dependency. Eventually, the determination will be made at step 34 whether to continue supervised detention 31 or whether the individual may be released from detention 30 to probation 36. Illustratively, although probation 36 could begin at any suitable time, it is not anticipated that probation 36 will occur any sooner than the end of phase II 70 as will be explained further below. Even during probation 36, however, the individual may still be subjected to periodic reporting 31, screening 32, and visiting 33 or reporting requirements as deemed necessary by the individual and/or the multidisciplinary team, including the supervising probation officer, the parole officer and/or other corrections official(s). The supervision, monitoring and implementing of the program 10 may be facilitated by certain hardware devices as will now be explained.

Referring now to FIG. 11, an illustrative implementation system 140 is depicted. The implementation system 140 illustratively may comprise one or more processing units 141, 142, 143, 144, 145, which may be stand alone units or may be interconnected, for example by some communications protocol, system, or network, 146. The communications system 146 may for example and without limitation be the Internet or World Wide Web, a telephone network; an intranet, a wide area network, a local area network, a WiFi network, a Bluetooth network, or 802.11 networks and the like. The processing units may be personal computers, servers, handheld devices, personal digital assistants (PDAs) and the like and may each have one or more software programs that help implement the program 10. Processing unit 141 may be located for example at the one or more locations where the evaluation step 20 takes place and may have software to help create a patient-centered database containing the information gathered during the evaluation 20. This software may then help the team develop the treatment for the individual and track the individual's progress. The processing units may help to monitor the individual during detention and allow the individual to check in and keep a diary and the like. This system may include for example one or more of the following illustrative monitoring devices, alone or in combination: a telephone, a digital camera, an ankle monitor, a breath-analyzer; a drug tester; a urine tester; a blood tester; a GPS system, and a communication device linked to one or more of the processing units. An illustrative example of one suitable ankle monitor is a Secure Continuous Remote Alcohol Monitor (“SCRAM”) sold by Alcohol Monitoring Systems, Inc. The SCRAM tests a wearer's perspiration for the presence of alcohol periodically, for example every thirty to sixty minutes, and transmits the results to a monitor or modem device periodically, for example once a day. The results can be posted on the Internet for review.

The interconnected processing units could but need not be used to facilitate virtual individual and/or group counseling sessions, whether scheduled or emergency in nature. For example, if an individual is unable to attend a scheduled session, for example because of illness, weather, transportation problems and the like, or if the individual needs an emergency session, a digital camera tied to a computer or a video tele-conferencing system could be used to connect the individual with team members and/or other participants or patients. It will be appreciated that the treatment program 10 could be implemented without any such hardware, relying instead upon the multidisciplinary team and their notes and the like.

The method 10 may further include a consultation step 40, or the evaluation step 20 may further comprise consultation step 40 as depicted in FIGS. 2 and 4. During the consultation step, the general program 10 is presented 41 to the individual and the individual or patient is oriented 42 on the various parameters of the program or method 10. For example and without limitation the individual is imparted with the program philosophy 43, policies 44, procedures 45, and patient rights 46. In addition to imparting and explaining the above parameters to the individual, the consultation step 40 further comprises giving or providing the individual with pertinent documents and other resources. So too, the individualized patient's treatment plan 47 will be presented, explained and discussed at this time.

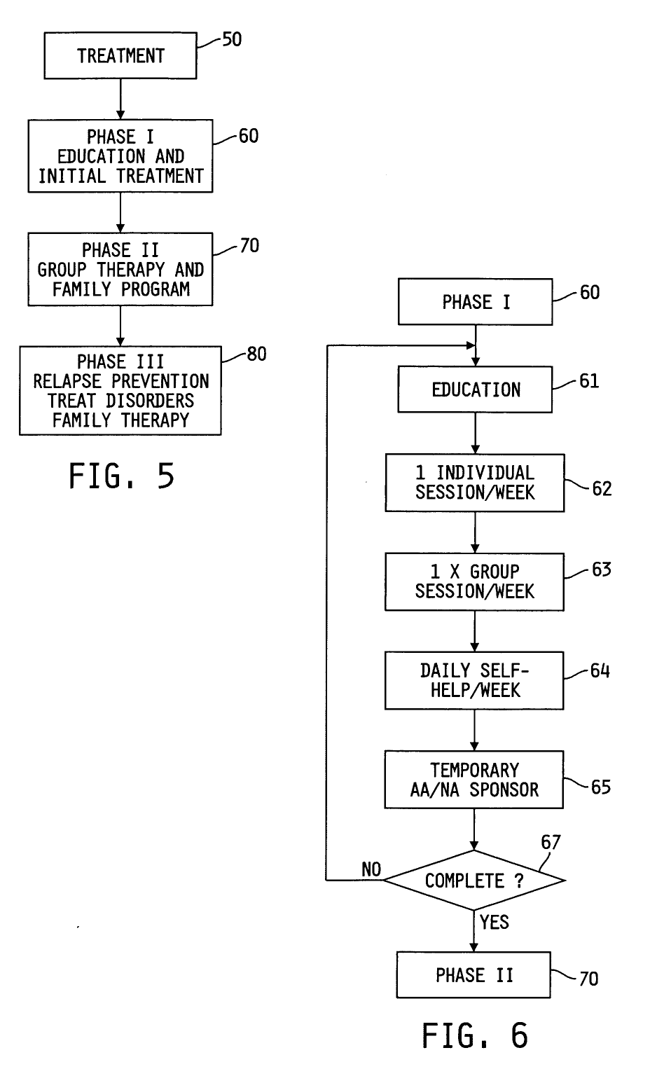

The treatment step 50 generally comprises three phases 60, 70, 80; however, these phases may be repeated from time to time if deemed necessary. The three phases 60, 70, 80 of this individualized treatment plan 50 may take from six (6) months to a year-and-a-half or longer to complete depending on the individual and the individual's individualized treatment plan as will be described below. As best depicted in FIG. 5, the three treatment phases illustratively and generally comprise: an initial education and counseling phase 60, Phase I; a therapy phase 70, Phase II; and a relapse prevention phase 80, Phase III. As will be discussed below, the relapse prevention phase 80 may include therapy aimed at resolving psychiatric and emotional disorders that may, or may not, lead to relapse if left untreated but may cause other problems in the patient's life.

The initial education and counseling phase 60, Phase I, generally includes education, counseling and personal-recovery-program participation by the individual or patient. Phase I is designed in part to help eliminate or at least reduce the patient's state of denial as it pertains to the patient's addiction. This phase may also provide a foundation of factual information from which the patient will be able to form new decisions to establish a pattern of long-term sobriety free from drugs and/or alcohol.

During Phase I, patients illustratively may undergo an education program 61. For example and without limitation, each patient might receive 16-20 hours of education; although, some patients may need additional education, and some may not need as much. One such suitable education program might be for example and without limitation the Prime for Life (PRI) program. A weekly individual counseling session 62 may also take place for each patient during Phase I. This session may be substituted with martial and/or family counseling sessions if clinically indicated. Each patient typically will also attend two (2) weekly group counseling sessions 63, one of which may be focused for example on the written development of a detailed self-analysis of the negative effects produced on the patient's life and on the lives of other people, by the patient's addiction(s). The other weekly group session may be focused on learning cognitive-behavioral theory and other psychological theories that will be utilized in the later phases of the program. This phase 60 illustratively may further include daily attendance, i.e., seven (7)-days-a-week, at a self-help program 64 such as for example and without limitation a 12-Step recovery program established by Alcoholics Anonymous (AA), Narcotics Anonymous (NA) or Rational Recovery (RR) and the like, which are known to those skilled in the art. The patient may also be required to have a self-help sponsor 65, which may be either temporary or permanent at this phase.

Phase I 60 of the program 10 is expected to have a typical duration of four (4) to eight (8) weeks. However, the actual length of Phase I 60, and each of the other phases 70, 80, will be determined by the measured progress of the patient rather than on a predetermined time limit. The program 10 takes into consideration the fact that patients may respond to treatment differently. Treatment 50 may be adapted to match this response to maximize effectiveness. Satisfying special criteria, unique to a patient, illustratively may be required prior to advancing from any one phase to another, for example from Phase I 60 to Phase II 70. These special criteria may be determined during the evaluation step 20, or it may arise during the course of any of the phases. The multidisciplinary team will make a determination of completion 67. If the team determines that the individual has not successfully completed or is not ready to move on to Phase II, then the individual may be kept within a continuing Phase I protocol 60, which may even include further group 63 and individual 62 therapy, or if serious violations of program policies have occurred, may be failed out of the program 10 altogether. In the instance of a patient in the target population, the patient may be discharged with treatment recommendations, or may be discharged to the judicial system for further processing; which may include for example, determination that the individual will now serve an executed sentence.

Phase II 70 of the program 10, in addition to perhaps continuing elements of the Phase I protocol 60, if deemed necessary, is aimed at treating the “core issues” of the patient's chemical dependency. The treatment in Phase II addresses behavioral and other issues initially raised and identified in the patient's self-analysis, combined with information obtained from the evaluation process 20. Weekly activities in Phase II illustratively may include: one (1) individual session 72, which illustratively may last from thirty minutes to one-and-a-half hours each; two (2) group therapy sessions 73, which illustratively may last from one (1) to two (2) hours each; three (3) to four (4) self-help sessions 74; one (1) family program session 76, which illustratively may last from one (1) to two (2) hours each. The patient should have a permanent self-help sponsor 75 by this time, if one was not already obtained during Phase I. The patient's self-analysis will be orally presented in Phase II group-therapy sessions and discussed with the patient's primary therapist and group members throughout the phase 70.

During Phase II 70, patients will be learning how to live happy, productive, fulfilling lives without for example alcohol and/or drugs. Common issues that may arise and are addressed in this phase illustratively may include but are not limited to: identifying and expressing feelings, dealing with relationships, how to communicate, overcoming shame, taking responsibility for one's feelings and behavior, learning how to have fun and enjoy life without the chemical(s), i.e., while sober, and regaining the trust of others.

Phase II of the program 10 may incorporate a family program 76 for spouses or significant others. The family program 76 sessions illustratively may occur on a weekly basis. Both the patient and the spouse (or significant other) may attend these sessions together. The family program 76 embraces the concept that the negative behaviors arising from, and magnified by, chemical dependency, affect family members as well as the addicted patient. Appropriate family members may be referred to, and encouraged to participate in relevant self-help programs appropriate for them, for example and without limitation, Al-Alon or Alateen, or other appropriate program(s) known in the art.

The length of Phase II 70 illustratively is expected to be approximately six (6) to nine (9) months (150-300 days). Like in Phase I, however, treatment may include special criteria and may be appropriately matched to the individual's progress and the severity of the progressive disease. The team will make a determination of completion 77. If the team determines that the individual has not successfully completed or is not ready to move on to Phase III 80, then the individual may be kept within a continuing Phase II protocol 70, may be returned to Phase I 60 for remediation consisting of successfully repeating at least a portion of the first phase 60, may be referred to some outside treatment if deemed necessary, or if serious violation of program policies have occurred, may be discharged from the program 10 altogether. As noted, a failure on the part of a target-population patient may result in that patient being discharged from the program and sent back to the judicial system for further processing.

Phase III 80, illustratively is focused on relapse prevention which includes without limitation treating any diagnosed psychiatric, emotional, family/relationship, family of origin or other issues that may serve to interfere with patient's ongoing recovery or quality of life. For example and without limitation controlling behavior that can lead to a relapse, such behavior is commonly known as “relapse triggers”; and controlling or treating other issues beyond the chemical dependency issues, which other issues, if left untreated, might sabotage the continued sobriety and well-being of the patient and family. These “other issues” may have been determined during the evaluation step 20, during the consultation 40 and/or during the on-going evaluation that takes place during the treatment 50 steps. In any event they are determined from a holistic evaluation of the patient to determine other issues that could lead to relapse or other significant life problems. Phase III 80, therefore, typically will be the most individualized and flexible phase of the program 10 and will possibly involve referral to staff clinicians other than the patient's primary therapist or outside clinicians/organizations to treat specific psychological or behavioral issues. Such issues illustratively may include without limitation psychological disorders that require additional treatment, for example and without limitation dysthymia (clinical depression), anxiety, bi-polar disorder, post-traumatic stress disorders, eating disorders, co-dependency, poor self-image and the like; or other dysfunctional behavior patterns, for example and without limitation, anger/rage, over-controlling of others, compulsive gambling and other addictive behaviors.

During Phase III 80, patients illustratively will attend a weekly relapse prevention group 81. This group 81 illustratively will help identify individual “relapse triggers,” for example and without limitation stressful social events, stressful life events, grief and loss, daily stressors, and the like, and help develop effective strategies to avoid relapse back into chemical use. In this phase 80 the focus for many patients may shift to marital and family issues; sometimes involving children and/or adolescent members of the family; therefore, weekly individual, martial or family therapy sessions 82 will also continue in Phase III 80 if needed. Phase III 80 may also include other specialized therapy 84 determined as explained above according to the individual patient's patient-centered treatment plan illustratively designed to further the patient's personal development and recovery. This other therapy targets other issues such as for example and without limitation the above described relapse triggers and psychological, psychiatric, physical, and physiological disorders. For example, some patients may participate in an anger-management group; others may need individual therapy for psychiatric/psychological disorders as mentioned above. If enough Phase III patients have a common issue they may be assigned to a specialized therapy group to treat that specific issue, for example and without limitation depression, anxiety, relationship issues, and the like. In addition, each patient illustratively will continue to attend a minimum of three (3) self-help program meetings 85 per week while in this phase of treatment.

The length of Phase III 80 illustratively is expected to be approximately two (2) to five (5) months. Like in Phase I and II, and as just noted, however, treatment may include special criteria and may be appropriately matched to the individual's progress and the severity of the progressive disease. The team will make a determination of completion 87 or successful discharge. If the team determines that the individual has not successfully completed or is not ready to move out of Phase III 80, then the individual may be kept within a continuing Phase III protocol 80, may be returned to Phase I 60 or Phase II 70 for remediation, may be referred to some outside treatment if deemed necessary, or if serious violations of program policies have occurred, may be discharged from the program 10 altogether. As already noted, a failure on the part of a target-population patient may result in that patient being discharged from the program and sent back to the judicial system for further processing.

In any event, if it is determined that the patient has successfully completed and should be discharged 89 from the treatment program 50, then the patient will proceed to the maintenance step 90 armed with a continuing care plan 88. The patient, along with one or more members of the team, will develop the comprehensive continuing care plan 88 prior to successful discharge 89 from the treatment program 50. This plan 88 will serve as a roadmap for the maintenance step 90 to assist the patient to continue the personal growth and recovery that was accomplished through successful completion of the treatment program 50. The continuing care plan 88 illustratively will specify what the primary therapist has recommended, and what the patient has agreed to do, to continue the progress that began during the method of treatment or program 10. The continuing care plan, for example and without limitation may address goals for the following areas: professional counseling/therapy (if clinically indicated), self-help participation, family relations, personal education, vocational training, community service/volunteerism, spiritual/religious, leisure activities and the like. The continuing care plan 88 may also include referral to other professionals and/or agencies, which may or may not comprise resources outside those of the multidisciplinary team.

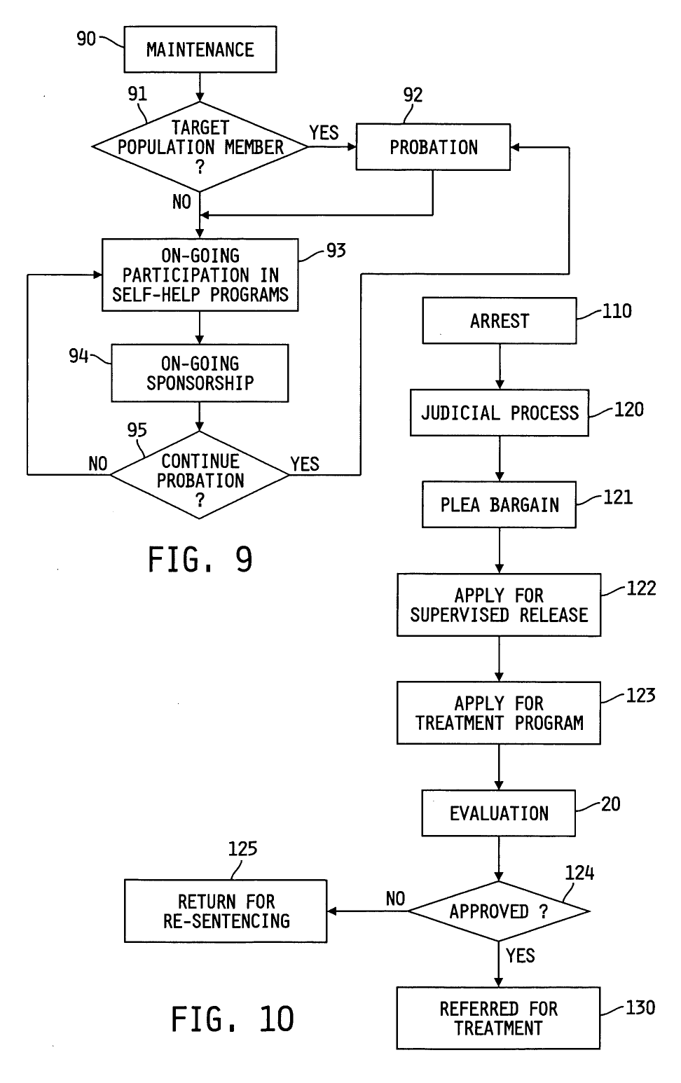

The continuing care plan 88 could be executed alone in the event that the discharge 89 is from the entire program 10, which likely will not be the case for at least an individual in the target population due to the likely probation requirement, or as part of an on-going formal aspect of the general program 10 known illustratively as the maintenance step 90 (FIG. 9). As previously noted, in accordance with the individualized continuing care plan 88, alone or as the roadmap for the maintenance step 90, maintenance treatment illustratively may include additional referrals to outside counseling and/or therapy such as for example and without limitation on-going participation in self-help programs 93, the maintenance of a sponsor 94, and, in the case of a patient from the target population, formal probation 92.

Upon successful completion of the Program the patient may choose to voluntarily seek private therapy services with one or more of the staff if clinically indicated (e.g. the patient wishes to continue individual therapy for family of origin issues or to do medication reviews with one of the psychiatrists).

For patients in the target population, namely, “probationers,” a pre-arranged agreement with the judicial sentencing authority may for example be that probationers participating in the Program will have a two (2) or three (3) year probation period; after successful completion of the Program a requirement of their probation will be to cooperate in an on-going follow-up study for the remainder of their probation. The supervising probation officer may choose to make their probation status very low risk as time passes. Some jurisdictions may choose to downgrade the felony conviction to a misdemeanor for those who successfully complete the Program and probation period.

If desired, the maintenance step 90 may also include an evaluation 95 step, which may result for example and without limitation in the individual being totally discharged 100 from the program 10, in the individual being retained in the maintenance program 90, in the individual being returned to an appropriate step within the treatment program 50 for remediation; or in revocation of probation 92 and return to the judicial process for further processing. Illustratively, an individual in the target population is identified 91 and placed on probation 92, if not already on probation, in accordance with the outcome of the judicial process (FIG. 10), and then follows the continuing care plan as just described, until the determination 95 is made that the individual has satisfied all of the conditions of probation 92. Thereafter, the individual may continue the maintenance step according to the continuing care plan without the probation restrictions.

Referring to FIG. 10, an illustrative depiction of the processing of the target population can be seen. An individual is arrested 110 for a crime, which may or may not have its roots in the chemical dependency, the individual goes through the judicial process 120, and the individual is referred 130 for evaluation 20. During the judicial process, depicted in FIG. 10, the individual illustratively enters into a plea bargain 121. As part of the plea bargain 121, the individual applies for supervised release 122 and applies for referral 123 to the treatment program 10 for dependency treatment. If the evaluation 124 of the application for supervised release 122 and the application for treatment 123 results in approval 126, then the individual in the target population is referred 130 for treatment. If the individual's application for supervised release 122 is denied or disapproved 124, and/or if the individual's application for treatment 123 is denied or disapproved 124, then he will be returned to the presiding judge for appropriate sentencing 125. Although the illustrative processing shows the individual entering a plea and applying for supervised release and dependency treatment as part of the plea bargain, namely, before sentencing, such application could occur after a conviction and/or sentencing. In addition, as noted above, the individual or offender may have already completed an executed sentence and may be on parole when referred to the treatment program 10. The length and conditions of the probation 92 will be determined in part by the judicial process 120, as will other punitive aspects, such as for example and without limitation, the surrender of the individual's driver's license until successful completion of the program and the consequences of failing the program. Such probation 93, for example and without limitation, may last from two (2) to five (5) years and may be determined by any number of factors including the individual's success during treatment and the judgment of the sentencing judge. Probation may also be coupled with an on-going program evaluation. For example and without limitation, an individual may be placed on probation for a three (3)-year period with a condition that they cooperate in an on-going outcome study. Such a study may, for example, be conducted by a college or university, a hospital, an individual clinician, a private contractor and the like. No matter the type or duration of the probation, the individual may be required to bear all or a portion of the costs associated therewith. For example, the individual might be required to pay the costs associated with monitoring an ankle bracelet such as a SCRAM unit. Similarly, the individual may even be required to bear all or a portion of the costs of the entire treatment program. It will be appreciated, that the length of the probation 93 may also be shortened if deemed warranted. So too, the individual's home detention, or the like, could be shortened and converted to probation during any portion of the treatment 50 if deemed warranted. Any such modifications must fall within the limitations of the law by the team and may need approval of the sentencing judge. Of course, for those not in the target population, probation may not even be a part of the treatment program 10, and/or may be determined and/or shortened by the team as deemed appropriate.

While the present invention has been described as having exemplary embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of treating a dependency, the method comprising the steps of:
evaluating an individual having a dependency;
developing an individualized treatment plan directed to helping the individual recover from the dependency;
treating the individual according to the treatment plan;
assessing the individual's progress toward recovering from the dependency;
discharging the individual according to defined criteria; and
providing the individual with maintenance treatment.

2. The method of claim 1 wherein a multidisciplinary team comprising licensed or certified professionals evaluates the individual.

3. The method of claim 2 wherein the evaluation step is a holistic evaluation comprising:
obtaining the individual's personal history;
conducting a mental evaluation of the individual;
conducting a physical evaluation of the individual; and
assessing the personal history, mental evaluation and physical evaluation to determine an individualized treatment plan tailored for the individual.

4. The method of claim 3 wherein the mental evaluation comprises a psychiatric evaluation and a psychological evaluation.

5. The method of claim 4 further comprising the step of consulting between at least one member of the multidisciplinary team and the individual.

6. The method of claim 5 wherein the consulting step comprises:
giving the individual an orientation of the treatment plan, which treatment plan comprises a generalized treatment program and the individualized treatment plan;
discussing with the individual the generalized treatment program;
discussing with the individual the philosophy of the treatment plan;
discussing with the individual the policies of the treatment plan;
discussing with the individual the procedures of the treatment plan;
discussing with the individual the individual's rights under the treatment plan; and
discussing with the individual the individualized treatment plan.

7. The method of claim 6 wherein the generalized treatment program comprises:
providing education and therapy sessions to the individual;
treating the individual for any disorders other than dependency;
providing relapse prevention counseling to the individual; and
developing a continuing care plan for the individual to be implemented upon the individual's successful completion and discharge from the treatment plan.

8. The method of claim 7 wherein counseling sessions comprise individual and group counseling sessions under the supervision of at least one member of the multidisciplinary team and further comprises self-help sessions outside of the supervision of the multidisciplinary team and with the help of a sponsor.

9. The method of claim 8 wherein the self-help sessions are selected from the list of self-help programs consisting of Alcoholics Anonymous and Narcotics Anonymous.

10. The method of claim 9 wherein the individualized treatment plan further comprises the steps of:
customizing the number and duration of the therapy sessions;
customizing the content of the therapy sessions during each phase;
adding the participation of family and significant others of the individual in therapy sessions if deemed necessary as provided in the individualized treatment plan; and
providing therapy treatment to the friends and significant others if deemed necessary as provided in the individualized treatment plan.

11. The method of claim 10 wherein an individual may be sent back to any previous stage for remedial therapy.

12. The method of claim 10 wherein successful completion of the treatment plan results in:
discharging the individual from the program;
implementing the continuing care plan for the individual, the continuing care plan including interviews with the individual and the individual's family members, significant others and friends over a certain period of time provided for in the individualized treatment plan; and
providing maintenance treatment as deemed necessary.

13. The method of claim 12 wherein maintenance treatment comprises:
on-going participation in self-help sessions; and
continuing a relationship with sponsor.

14. The method of claim 13 wherein the family and significant other sessions may include their participation in family self-help programs.

15. The method of claim 14 wherein the individual being treated is a member of a target population comprising individuals charged with committing one or more non-violent crimes.

16. The method of claim 15 further comprising the steps of:
allowing the individual to apply for supervised release;
referring the individual for analysis of suitability criteria for treatment carried out as part of a home-detention treatment program for the individual's dependency.

17. The method of claim 16 wherein the suitability criteria comprises:
volunteering for the home-detention program;
undergoing the holistic evaluation;
agreeing to complete the treatment plan;
agreeing to abide by the treatment plan's policies and procedures;
agreeing to attend all scheduled treatment sessions;
determining that the individual's family and significant other can participate;
determining that the individual is not accused or previously convicted of a crime involving violence or other defined acts; and
being determined to be treatable by the multidisciplinary team.

18. The method of claim 17 wherein a determination that an individual in the target population is not suitable for the home-detention treatment program at any point in the program results in referring the individual back to the criminal justice system for further adjudication.

19. The method of claim 18 wherein the referral back to the criminal justice system includes recommendations for treatment outside of the home-detention treatment program.

20. The method of claim 17 wherein the home-detention treatment program further comprises:
supervising the individual by:
placing the individual on home detention throughout the treatment;
requiring the individual to phone a-detention program representative periodically as directed;
subjecting the individual to drug screenings;
visiting the individual at the individual's home; and
fitting the individual with one or more accountability devices connected to the; and
placing the individual on probation.

21. The method of claim 20 wherein the maintenance step for individuals in the target population further comprises probation.

22. A method of treating a dependency, the method comprising the steps of:
evaluating an individual having a dependency, the evaluating step comprising:
obtaining the individual's personal history;
conducting a mental evaluation of the individual;
conducting a physical evaluation of the individual; and
assessing the personal history, mental evaluation and physical evaluation to determine a treatment plan tailored for the individual;
developing an individualized treatment plan directed to helping the individual recover from the dependency;
treating the individual according to the treatment plan, the treatment plan comprising:
a generalized treatment program including
providing education and therapy sessions to the individual;
treating the individual for any disorders other than dependency;
providing relapse prevention counseling to the individual; and
developing a continuing care plan for the individual to be implemented upon the individual's successful completion and discharge from the treatment plan; and
an individualized treatment plan including
customizing the number and duration of the therapy sessions;
customizing the content of the therapy sessions during each phase;
adding the participation of family and significant others of the individual in therapy sessions if deemed necessary as provided in the individualized treatment plan; and
providing therapy treatment to the family and significant others if deemed necessary as provided in the individualized treatment plan;
assessing the individual's progress toward recovering from the dependency;
discharging the individual; and
providing the individual with maintenance treatment.

23. The method of claim 22 wherein a multidisciplinary team comprising licensed or certified professionals implements the treatment program.

24. A method of treating a dependency, the method comprising the steps of:
evaluating an individual having a dependency and accused of a non-violent crime, the evaluating step comprising:
determining the individual's suitability for a home-detention treatment program, the criteria for suitability including the individual:
volunteering for supervised release;
volunteering for the home-detention program;
undergoing a holistic evaluation comprising
obtaining the individual's personal history;
conducting a mental evaluation of the individual; and
conducting a physical evaluation of the individual;
agreeing to complete a treatment plan directed to helping the individual recover from the dependency, the treatment plan comprising
a generalized treatment program including
providing education and therapy sessions to the individual;
treating the individual for any disorders other than dependency;
providing relapse prevention counseling to the individual;
developing a continuing care plan for the individual to be implemented upon the individual's successful completion and discharge from the treatment plan; and
an individualized treatment plan including
customizing the number and duration of the therapy sessions;
customizing the content of the therapy sessions during each phase;
adding the participation of family and significant others of the individual in therapy sessions if deemed necessary; and
providing therapy treatment to the family and significant others if deemed necessary;
agreeing to abide by the treatment plan's policies and procedures;
agreeing to attend all scheduled treatment sessions;
determining that the individual's family and significant others can participate;
determining that the individual is not accused or previously convicted of a crime involving violence or other defined acts; and
being determined to be treatable by the multidisciplinary team;
treating the individual according to the treatment plan;
assessing the individual's progress toward recovering from the dependency;
discharging the individual; and
providing the individual with maintenance treatment.

25. The method of claim 24 wherein a multidisciplinary team comprising licensed or certified professionals implements the treatment program.
